(19) United States
(12) Patent Application Publication
(10) Pub. No.: US 2024/0340948 A1
(43) Pub. Date: Oct. 10, 2024

(54) CHANNEL OCCUPANCY TIME (COT) SHARING IN CASES OF MULTIPLE TRANSMISSION RECEPTION POINTS (MTRP)

(71) Applicant: QUALCOMM Incorporated, San Diego, CA (US)

(72) Inventors: Giovanni CHISCI, San Diego, CA (US); Jing SUN, San Diego, CA (US); Xiaoxia ZHANG, San Diego, CA (US); Yan ZHOU, San Diego, CA (US); Vinay CHANDE, San Diego, CA (US); Arumugam CHENDAMARAI KANNAN, San Diego, CA (US); Siyi CHEN, Beijing (CN)

(21) Appl. No.: 18/294,968

(22) PCT Filed: Oct. 14, 2021
(86) PCT No.: PCT/CN2021/123796

§ 371 Date: Feb. 2, 2024

(51) Int. Cl. H04W 74/0808; H04W 74/00

(52) U.S. Cl. CPC H04W 74/0808; H04W 74/006

(57) ABSTRACT

Aspects of the present disclosure relate to wireless communications, and more particularly, to techniques for channel access for wireless communications. One aspect provides a method for wireless communications at a user equipment (UE). The method generally includes obtaining a channel occupancy time (COT) structure information (COT-SI) message and obtaining at least one downlink control information (DCI) indicating multiple beams and listen before talk (LBT) scheme indications associated with the multiple beams. The method generally includes determining an LBT scheme to be used for transmission via each of the multiple beams based on the LBT scheme indications and the COT-SI message, and outputting signaling for transmission on each of the multiple beams based on the LBT scheme.

### INTRODUCTION

Aspects of the present disclosure relate to wireless communications, and more particularly, to techniques for channel access for wireless communications, for example, in unlicensed frequency bands.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communications at a user equipment (UE). The method generally includes obtaining a channel occupancy time (COT) structure information (COT-SI) message and obtaining at least one downlink control information (DCI) indicating multiple beams and listen before talk (LBT) scheme indications associated with the multiple beams. The method generally includes determining an LBT scheme to be used for transmission via each of the multiple beams based on the LBT scheme indications and the COT-SI message, and outputting signaling for transmission on each of the multiple beams based on the LBT scheme.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station (BS) and user equipment (UE).

FIGS. 3A-3D depict various example aspects of data structures for a wireless communication network.

FIG. 4 depicts an example timing diagram for a listen before talk (LBT) mechanism, in accordance with aspects of the present disclosure.

FIG. 5A depicts an example co-located multiple transmission reception points (mTRP) system.

FIG. 5B depicts an example non-co-located mTRP system.

FIG. 6 depicts an example scenario where a UE is unable to determine which whether the mTRP system is co-located or non-co-located.

FIG. 7 is a flow diagram illustrating example operations for wireless communication by a UE, in accordance with aspects of the present disclosure.

FIGS. 8A, 8B, 8C and 8D depict example channel occupancy time (COT) sharing scenarios based on COT structure information (COT-SI) and downlink control information (DCI) scheduling.

FIG. 9 depicts example DCI fields indicating transmission configurator indicator (TCI) states and LBT schemes.

FIGS. 10A, 10B, and 10C depict example COT sharing scenarios during single DCI scheduling.

FIGS. 11A, 11B and 11C depict example COT sharing scenarios during multi-DCI scheduling.

FIG. 12 depicts aspects of an example communications device.

### DETAILED DESCRIPTION

As the demand for mobile broadband access continues to increase, using shared radio frequency spectrum, which may include unlicensed radio frequency spectrum, has proven helpful to solve the spectrum congestion problem for future wireless needs. Using shared radio frequency spectrum not only helps to meet the growing demand for mobile broadband access but also helps to advance and enhance the user experience with mobile communications. However, the shared radio frequency spectrum may carry other transmissions, and therefore, techniques such as listen before talk (LBT) and clear channel assessment (CCA) may be used in an effort to prevent excessive interference.

A channel occupancy time (COT) generally refers to the maximum continuous transmission time a device has on a channel after channel sensing. Uplink transmissions may be sent by a user equipment (UE) based on a COT initiated by the UE (e.g., after channel sensing by the UE) or based on a base station (BS) initiated COT. It may be important for the BS and UE to be in agreement on which COT is used, so the UE knows when to send the uplink transmission and so the BS knows when to expect the transmission.

There are different LBT schemes with different levels of stringency. A UE may receive, from a BS, a COT structure information (COT-SI) message (e.g., indicating a specific beam), and receive downlink control information (DCI) scheduling transmissions using various beams. The beams to be used for transmission may be directed towards different transmission-reception points (TRPs) in a multi-TRP system. For sidelink, a UE may receive a DCI (e.g., with DCI format 3_0) containing dynamic grant to perform one or more sidelink transmissions (e.g., via a PC5 interface) to other UEs. The dynamic grant may schedule resources for transmission of the same transport block (TB) in up to three different slots within a window of 32 slots. The TB may be transmitted to different UEs using different beams, as configured via DCI. The UE may determine to use no LBT when responding to the BS (or transmitting to other UEs on sidelink) on the specific beam associated with the COT-SI for the COT owned by the BS. However, the UE may not know the LBT scheme to be used when responding using other beams scheduled in the DCI.

Certain aspects of the present disclosure are directed techniques for determining an LBT scheme to be used when responding to a BS (or transmitting to other UEs on sidelink) using different beams associated with different destinations (e.g., TRPs or UEs). For example, a UE may determine an LBT scheme to be used for transmission via multiple beams based on a COT-SI message and LBT scheme indications from DCI. In some aspects, a UE acquires a COT for each transmission configuration indicator (TCI) state (e.g., per beam). In some aspects, a UE acquires a COT for each scheduling device (e.g., per BS), as described in more detail herein.

### Introduction to Wireless Communication Networks

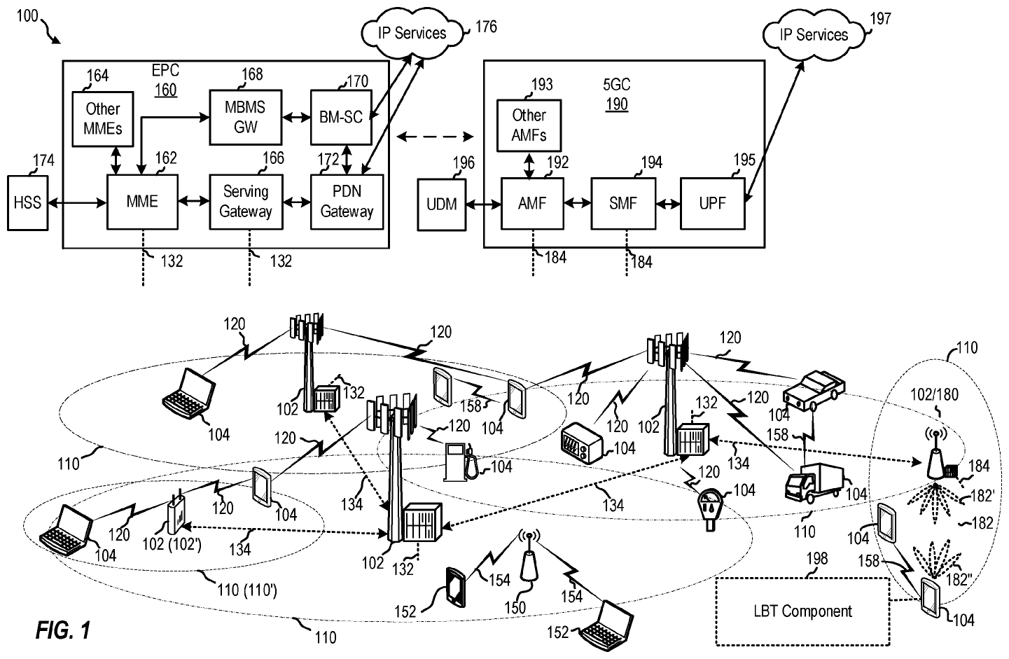

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless network 100 includes LBT component 198, which may be configured to determine a listen before talk (LBT) scheme to be used for transmission via multiple beams based on LBT scheme indications and a COT structure information (COT-SI) message.

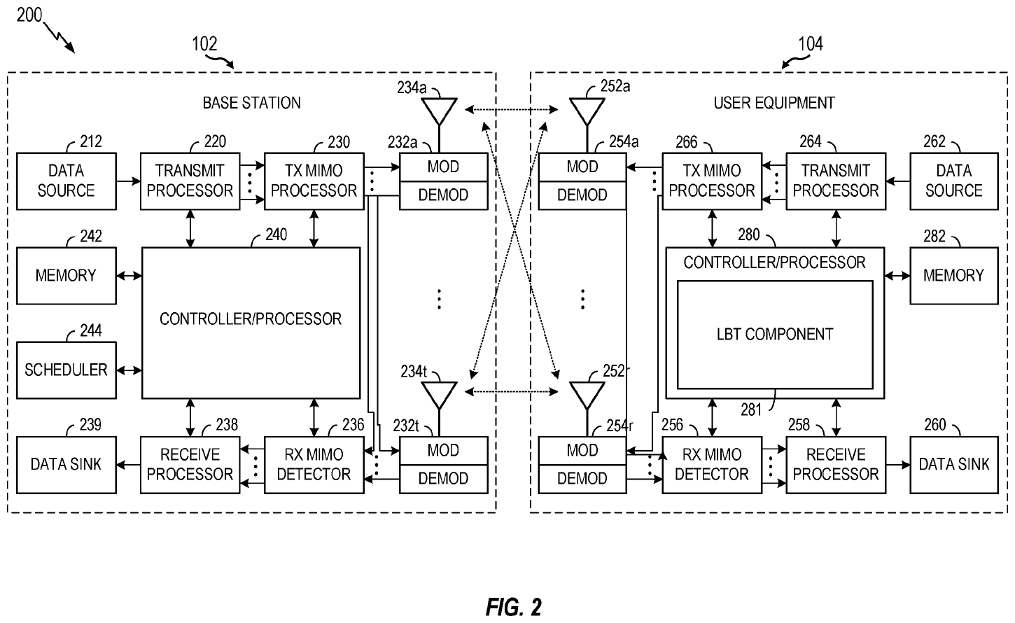

FIG. 2 depicts components 200 of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes LBT component 281, which may be representative of LBT component 198 of FIG. 1. Notably, while depicted as an aspect of controller/processor 280, LBT component 281 may be implemented additionally or alternatively in various other aspects of user equipment 104 in other implementations.

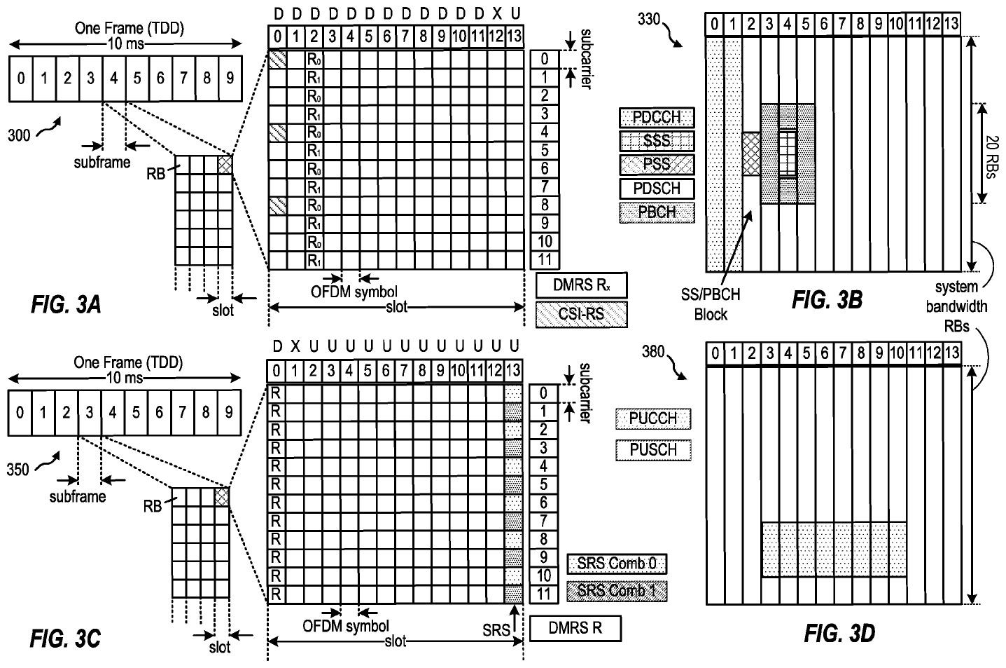

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Introduction to LBT Channel Access

In some scenarios where unlicensed frequency bands are used, to help achieve co-existence with other technologies, a channel access mechanism, referred to as listen before talk (LBT), may be used. LBT generally refers to a contention-based protocol that may allow users to share a wireless channel with little or no pre-coordination.

Different types of LBT schemes exist. For example, four LBT categories may be defined for channel access procedure. Category (Cat) 1 LBT allows immediate transmission after a short switching gap (e.g., of 16 μs) (no CCA). Cat2 LBT refers to LBT without random back-off, with a deterministic CCA period (e.g., 25 μs). Cat3 LBT refers to LBT with random back-off and a variable extended CCA period, randomly drawn from a fixed-sized contention window. Cat4 LBT refers to LBT with random back-off and a variable extended CCA period, randomly drawn from a variable-sized contention window, whose size can vary based on channel dynamics.

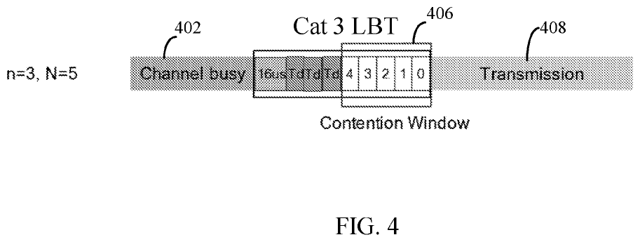

FIG. 4 illustrates a contention window (CW) for a category-3 (CAT-3) LBT, in some aspects. As illustrated, after a channel busy period 402, a transmitter may begin a defer period during which the node defers any transmission. The defer period may include a defer duration of 16 us, plus one or more defer time intervals (Td), as illustrated. For example, a quantity of n defer time intervals (Td) may be implemented, n being related to a channel access priority class (CAPC) of the node, and the typical value for Td may be 9 us. After the defer duration (16 us and n Td) CW 406 begins. The CW 406 may have a duration of N×Td, N being a randomly selected integer uniformly distributed between 0 and a contention window size (CWS). The CWS may be updated using feedback on a channel, as described in more detail herein. Channels without explicit feedback may use the CWS last updated by channels with explicit feedback and may use the same CAPC if such channels exist. Otherwise, such channels may use the minimum CWS (CWSmin) corresponding to the CAPC. As illustrated, a transmission 408 may occur after the CW 406. While Cat3 LBT uses a variable CWS, Cat2 LBT may use a fixed CWS. The CWS may be any suitable size for Cat2 LBT, such as 5 us, 8 us, or 13 us. Moreover, as described herein, Cat3 LBT uses a random back-off period, while Cat2 LBT uses a fixed back-off period.

Unlicensed bands may be used for a number of different communication service types, such as ultra-reliable low latency communications (URLLC). URLLC may refer to a service category designed to accommodate emerging services and applications that have stringent latency and reliability specifications. URLLC may be used, for example, in industrial Internet of Things (IIoT) scenarios where devices may be assumed to communication in a controlled environment.

What constitutes a controlled environment may vary. For example, in an extreme case, the environment may be fully controlled such that there are no other radio access technologies (RATs) or other operators operating in the coverage. In such an environment, the LBT may virtually always pass, and the system operation may be relatively straightforward. In other words, the UE may not perform LBT at all. However, LBT may be performed (e.g., for regulation compliance only), but LBT failures may not be expected.

A more general case, with less stringent control, may involve a factory owner/operator, for example. While a factory owner/operator may be able to control the environment to some extent, it is possible that there may be some other RAT operating with non-zero probability. For example, for a Wi-Fi device, an access probe may be transmitted from a station (STA) even when an access point (AP) is not deployed (e.g., while the owner/operator may enforce that no WiFi AP may be deployed in the factory floor, it may be difficult to ensure no employee brings in a device, such as their smart phone).

Aspects Related to Channel Occupancy Time (COT) Sharing for Cases of Multiple Transmission Reception Points (mTRP)

Various channel access modes may be used for communication during a channel occupancy time (COT) For example, listen before talk (LBT) and no-LBT channel access modes may be supported for operation (e.g., in a 60 GHz band). For regions where LBT is not mandated, both LBT and no-LBT modes of operations may coexist. In other words, a network may choose an LBT scheme for a user equipment (UE) to improve performance.

Channel occupancy time (COT) sharing involves performing no LBT (Cat1 LBT) or potentially a measurement at the device to which the COT is shared before it can perform transmissions. COT sharing from an initiating device transmission to a responding device transmission may be implemented based on two alternatives. In a first alternative, there may be no maximum gap defined between the initiating device transmission and responding device transmission. A responding device transmission can occur without LBT (e.g., also referred to as Cat1 LBT) with any gap within the maximum COT duration. In a second alternative, a maximum gap “Y” may be defined, such that a responding device transmission can occur without LBT only if the transmission starts within Y from the end of the initiating device transmission. If the responding device transmission starts after Y from the end of the initiating device transmission, a Cat 2 LBT (e.g., CCA) is performed before the responding device transmission.

If COT sharing is not used, the transmitter may perform COT acquiring scheme (e.g., perform LBT to acquire the COT before transmission). A COT acquiring scheme may refer to Cat3 LBT or Cat4 LBT. Generally, Cat1 LBT (e.g., no LBT) is less stringent than Cat2 LBT, and Cat2 LBT is less stringent than Cat3 LBT or Cat4 LBT.

When multiple transmission/reception points (mTRPs) are involved, a well-defined BS/UE behavior with respect to usage of COT sharing should be provided. An mTRP system may support a single downlink control information (DCI) field transmission configuration indication (TCI). For example, a single DCI field TCI may indicate one or two TCI states associated with a code point for single DCI based mTRP mechanism. However, for multi-DCI based mTRP mechanism, the single DCI field TCI indicates only one TCI state associated with a code point. Generally a TCI-state corresponds to a beam for transmission to a specific TRP in an mTRP system.

Multi-beam transmissions mean that there is a beam per antenna panel, where the antenna panels may be co-located or non-co-located. For any multi-beam transmission where each beam corresponds to a TCI state, a UE has to determine the beams on which the UE is allowed to transmit for any given grant. For example, the UE may determine one or more of: (a) channel access to be used (e.g., Cat3 LBT (e.g., eCCA) for obtaining a COT) (b) whether there is receiver assistance (e.g., either Cat3 LBT for a new COT or Cat2 LBT on a pre-existing COT), and (c) whether to implement COT sharing (e.g., Cat2 LBT or Cat1 (no-LBT)). For COT sharing, if there is a multi-panel transmission, it should be determined whether LBT is to be performed (e.g., the COT is to be cleared) in order to transmit on each TCI (beam).

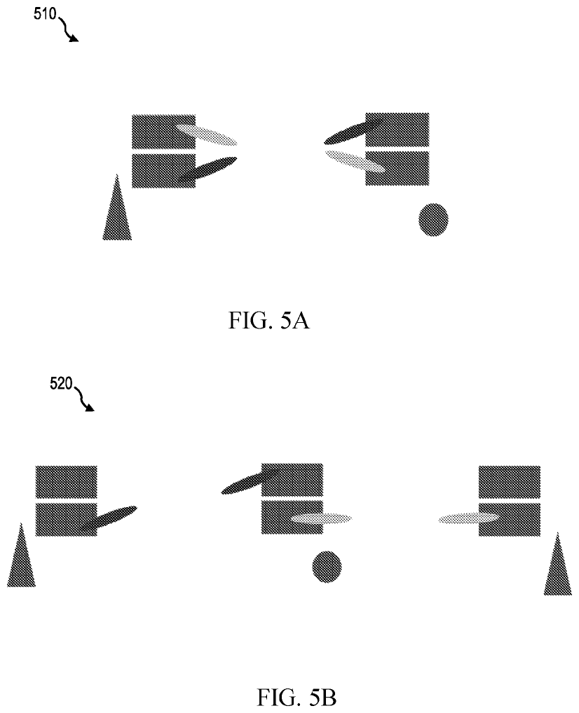

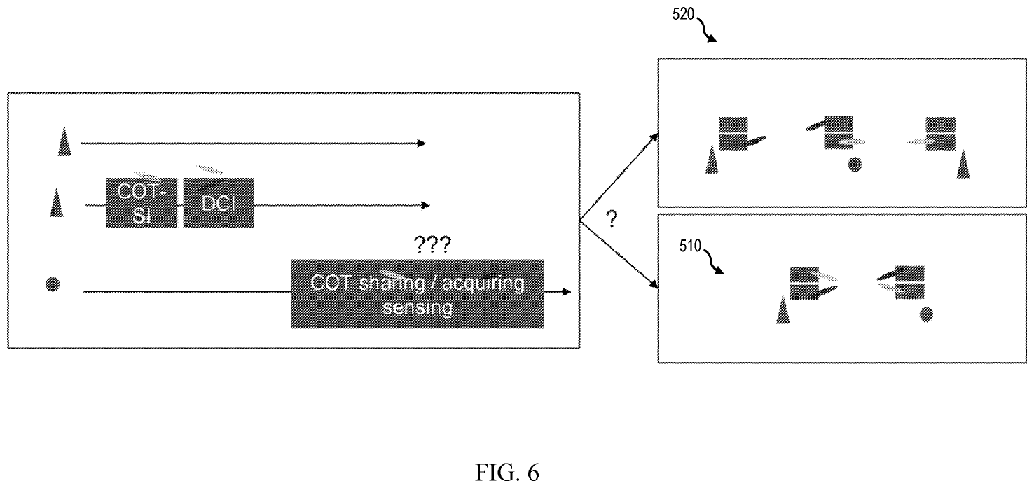

FIG. 5A depicts an example co-located mTRP system 510, in accordance with certain aspects of the present disclosure. For example, a user equipment (UE) may send uplink transmissions to a single base station (BS) on multiple beams, as shown. As used herein, mTRP is considered to be co-located when the multiple TRPs (each associated with a beam) are part of the same BS.

FIG. 5B depicts an example non-co-located mTRP system 520, in accordance with certain aspects of the present disclosure. For example, a UE may send uplink transmissions to multiple BSs on multiple beams. As used herein, mTRP is considered to be non-co-located when multiple TRPs are part of different BSs, as shown in FIG. 5B.

Transmissions on beams scheduled in a DCI are to be used during a valid COT for which a COT-SI message is received. In some implementations, a responder may respond to a device that owns a COT without any restriction on the beams used for the response. However, without knowing whether the mTRP system is co-located or non-co-located, a UE may not know whether beams scheduled in downlink control information (DCI) are for the device that owns the associated COT, and thus, may not know the LBT scheme to be used for each beam.

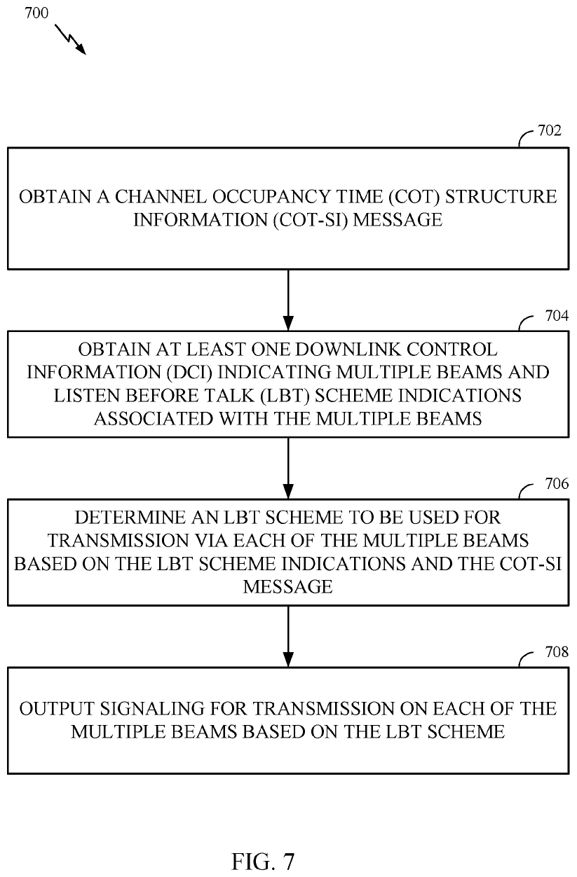

FIG. 6 illustrates an example scenario where a UE is unable to determine whether the mTRP system is co-located or non-co-located. If a UE receives a scheduling via DCI with multiple TCI states (e.g., beams) from a single BS, the UE cannot tell what BS (e.g., the same BS or different BSs) is the destination of transmissions associated with each TCI state. In other words, the UE cannot distinguish between the case of co-located mTRP (e.g., co-located mTRP system 510 shown in FIG. 5A) and the case of non-co-located mTRP (e.g., non-co-located mTRP system 520 in FIG. 5B). This being combined with receiving a COT-SI message only on some of the scheduled TCI states, it is difficult for the UE to determine which beams can share a COT (e.g., use CAT1 LBT) and which beams have to acquire a COT. Certain aspects of the present disclosure are directed to determining LBT schemes for beams scheduled in DCI.

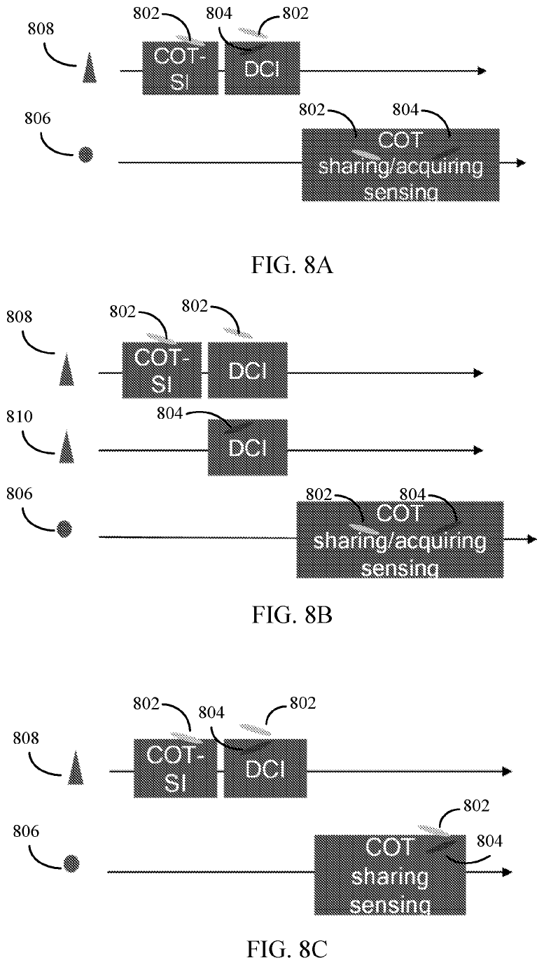

FIG. 7 depicts a flow diagram illustrating example operations 700 for wireless communication by a UE, in accordance with aspects of the present disclosure. For example, operations 700 may be performed by the UE 104 shown in FIGS. 1 and 2. The operations 700 may be implemented as software components that are executed and run on one or more processors (e.g., controller/processor 280 of FIG. 2). Further, the transmission and reception of signals by the UE in operations 700 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

Operations 700 may begin, at block 702, with a UE obtaining a COT-SI message. At block 704, the UE obtains at least one DCI indicating multiple beams and LBT scheme indications associated with the multiple beams. At block 706, the UE determines an LBT scheme to be used for transmission via each of the multiple beams based on the LBT scheme indications and the COT-SI message. At block 708, the UE outputs signaling for transmission on each of the multiple beams based on the LBT scheme.

According to aspects of the present disclosure, a policy for uplink mTRP and LBT may be implemented. The policy may provide that, whenever an mTRP scheduling over several TCI states is received, the uplink transmission depends on the LBT indication in DCI and the existence of a COT on the indicated beams.

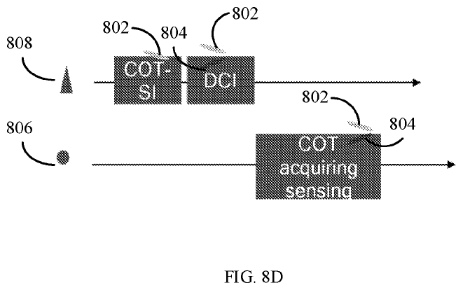

A policy may be configured for a UE to change (or “upgrade”) to a less stringent LBT scheme (e.g., from Cat3 to Cat 1 or Cat2 LBT). Specifically, if a UE is scheduled for uplink on multiple beams, referred to via their TCI state information, and is to perform an LBT (e.g., via DCI scheduling indication), the UE can perform the LBT on the different beams according to a first upgrade policy, and then transmit on those beams according to a second transmission policy. Various upgrade policies are described in more detail with respect to FIGS. 8A-8D.

FIG. 8A depicts an example scheduling scenario in which a UE receives a single DCI and determines an LBT scheme based on a first upgrade policy. In the first upgrade policy, COTs are used per-TCI state to respond to each TCI, linking the COTs with the corresponding TRP. For example, the UE 806 may receive an indication of a first beam 802 from the COT-SI message. The UE 806 may then receive a DCI from BS 808 indicating the first beam 802 and a second beam 804. Based on the COT-SI message and the DCI, the UE 806 may then determine to upgrade the LBT scheme of the first beam 802. However, because the COT-SI message did not indicate the second beam 804, the UE 806 may still perform a more stringent LBT scheme (e.g., COT acquiring scheme such as Cat3 or Cat4 LBT) for the second beam 804.

FIG. 8B depicts an example scheduling scenario in which a UE receives multiple DCI from different TRPs and determines an LBT scheme based on the first policy version. As illustrated, the UE 806 may receive an indication of a first beam 802 from a first BS 808 in the COT-SI message. The UE 806 may then receive a first DCI from the first BS 808 indicating the first beam 802. The UE 806 may also receive a second DCI from a second BS 810 indicating a second beam 804. Based on the COT-SI message and the first DCI, the UE 806 may then determine to upgrade the LBT scheme of the first beam 802. However, since a COT was not received for the second beam 804, the UE 806 may still perform a more stringent LBT scheme (e.g., COT acquiring scheme such as Cat3 or Cat4 LBT) for the second beam 804.

FIG. 8C depicts an example scheduling scenario in which a UE receives a DCI and determines an LBT scheme based on a second upgrade policy. In the second upgrade policy, the LBT scheme for each TCI may be determined on a per-scheduling device basis. For example, the second upgrade policy relates the COT to be shared with the scheduling device (e.g., a BS which may include one or multiple TRPs), instead of with receiving TRPs. As illustrated, the UE 806 may receive from BS 808 an indication of a first beam 802 from the COT-SI. The UE 806 may then receive a DCI indicating the first beam 802 and a second beam 804. Based on the COT-SI message and the DCI, the UE 806 may then determine to upgrade the LBT scheme of the first beam 802. Additionally, because a COT was obtained for the first beam 802, the UE 806 may determine to upgrade the LBT scheme of the second beam 804 as well, since a COT was received for at least one of the beam 802, 804 from the scheduling device (e.g., BS 808).

In some aspects, an LBT scheme for beams may be upgraded using an all-or-nothing approach (e.g., as part of the upgrade policy described herein). Using the all-or-nothing upgrade approach, if transmission for one TCI state is to use a COT acquiring scheme (e.g., since a COT has not yet been initiated on that TCI state), then all transmission for the TCI states should be implemented with the COT acquiring scheme (e.g., even though one of the TCI states is indicated by the COT-SI). In other words, if less than all of the TCI states can be upgraded to a less stringent LBT scheme, then none of the TCI states can be upgraded.

FIG. 8D depicts an example scheduling scenario in which a UE 806 receives DCI and determines an LBT scheme based on the first upgrade policy and an all-or-nothing approach. The COT-SI message indicates the first beam 802, and the DCI indicates the first beam 802 and the second beam. The DCI may indicate that Cat3 LBT is to be used for the second beam 804, as an example. As shown, although the COT-SI message may indicate the first beam 802 (which would otherwise allow an upgrade of the LBT scheme for beam 802), both the first beam 802 and the second beam 804 may be transmitted using Cat3 LBT since the COT-SI message did not indicate the second beam 804 and an all-or-nothing approach is being used.

Alternatively, an LBT scheme for beams may be upgraded using a partial approach. Under the partial approach, the UE may selectively upgrade the LBT on some TCI states. For example, the operations described with respect to FIGS. 8A and 8B use the partial approach since only one of the beams 802, 804 is being upgraded. The UE may perform Cat3 LBT only on the TCI states where a COT has not been initiated yet, and perform Cat1/Cat2 LBT to share the existing COTs.

In some aspects, a transmission policy to control the UE's response may be configured. For example, the UE response may be determined using an all-or-nothing transmission policy. Under the all-or-nothing transmission policy, a UE may only transmit a response on all indicated TCIs if all TCIs have either been obtained or shared a COT. In other words, the transmission is either performed on all beams if LBT for all beams are successful or on none of the beams.

Alternatively, UE response transmissions can be determined using a partial transmission policy, under which the transmission can happen selectively on some TCI states. In other words, the UE may transmit only on TCIs that either obtain or share a COT. The decision to use an all-or-nothing approach versus a partial approach (e.g., with regards to the upgrade policy or transmission policy) may be controlled via a radio resource control (RRC) parameter.

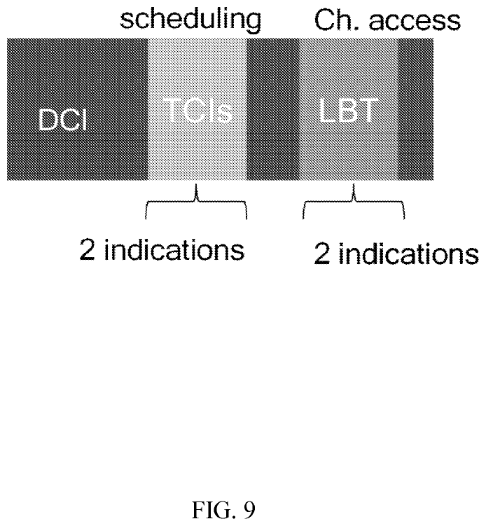

FIG. 9 depicts example DCI fields indicating TCI states and LBT schemes. In certain aspects, the LBT scheme that the UE should use is directly indicated by a DCI field. The DCI field indicating the LBT schemes can also host a number of LBT indications from 1 to the number of TCI indications in the scheduling. In certain aspects, a single DCI scheduling can host one or two TCI states.

If the UE receives one or more COT-SI messages over one or more beams, then the UE may try to share the associated COTs over the one or more beams (e.g., upgrade the LBT indication (e.g., Cat3) to COT sharing LBT (e.g., Cat2 or Cat1)). Under a first alternative, the TCI state of the COT can be explicitly included in a field of the COT-SI (e.g., explicit dynamic signaling of COT beams).

Under a second alternative, the TCI state of the COT may be deduced by the quasi-co-location (QCL) relation of a physical downlink control channel (PDCCH) carrying the COT-SI message (i.e., implicit dynamic signaling of COT beams). In this case, if a UE receives DCI scheduling from a single BS, only the single TCI state for COT-SI message (e.g., in a control resource set (CORESET) 0) may be used. On the other hand, if different BSs transmit DCIs to the UE, then each COT-SI message can be on a different TCI state (e.g., of CORESET 0 related to the cell-ID associated with each BS).

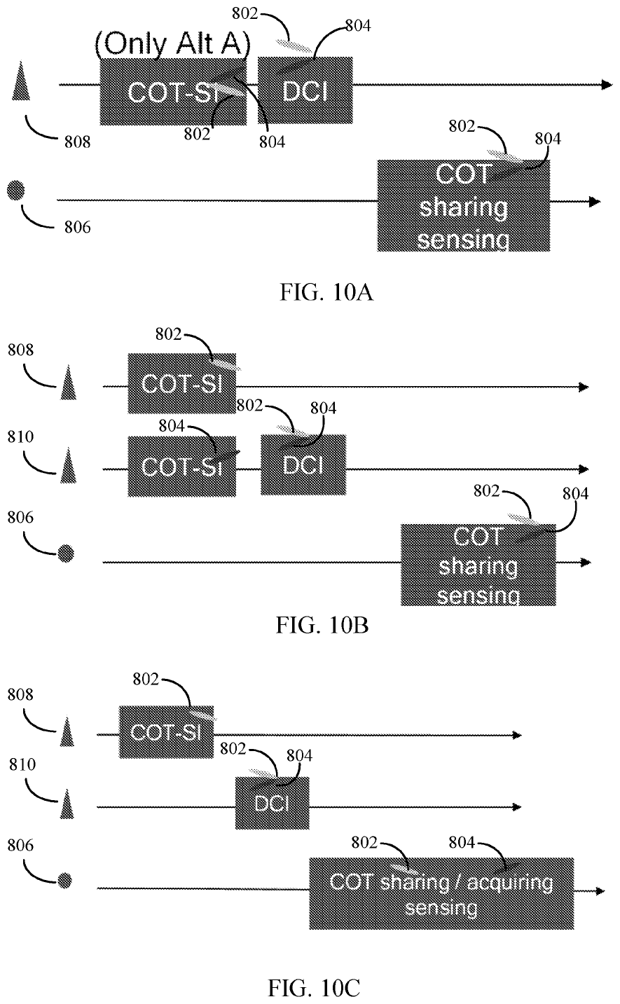

FIGS. 10A, 10B, and 10C depict example COT sharing scenarios using single DCI scheduling. FIG. 10A depicts an example COT sharing scenario where an explicit indication of TCI-state is included in the COT-SI message. As shown, the UE 806 may receive a COT-SI message indicating a first beam 802 and a second beam 804 (e.g., explicitly). The UE 806 then receives a DCI indicating both the first beam 802 and the second beam 804. In this example, the TCI state of each COT is explicitly included in a field of the COT-SI. The UE may implement COT sharing for both beams 802, 804, as shown as both beams are indicated by the COT-SI message.

As shown in FIG. 10B, the UE 806 may receive a COT-SI message from a BS 808 indicating a first beam 802 (e.g., explicitly or implicitly, as described). The UE 806 also receives a COT-SI message from another BS 810 indicating a second beam 804. The TCI state (i.e., beam) of each COT may be explicitly included in a field of each COT-SI message. In some aspects, the UE 806 may deduce the TCI state of each COT-SI message based on the QCL relation of the PDCCH carrying the COT-SI message. As shown, the UE 806 may also receive a DCI from BS 810 indicating both the first beam 802 and the second beam 804. Then, because a COT was obtained for the first beam 802 and the second beam 804, the UE 806 may determine to upgrade the LBT scheme of both beams.

As shown in FIG. 10C, the UE 806 may receive a COT-SI message from a BS 808 indicating a first beam 802. The TCI state (e.g., beam) of the COT for the first beam 802 is explicitly included in a field of the COT-SI message, in some aspects. In some aspects, the UE 806 may deduce the TCI state of the COT-SI message (e.g., that the COT is associated with the first beam 802) based on the QCL relation of the PDCCH carrying the COT-SI message. As shown, the UE 806 may also receive a DCI message from another BS 810 indicating the first beam 802 and a second beam 804. Based on the COT-SI and the first DCI, the UE 806 may then determine to upgrade the LBT scheme of the first beam 802 (e.g., using the partial upgrade policy). However, since a COT was not received for the second beam 804, the UE 806 may still perform a more stringent LBT scheme for the second beam 804 (e.g., based on the partial upgrade policy).

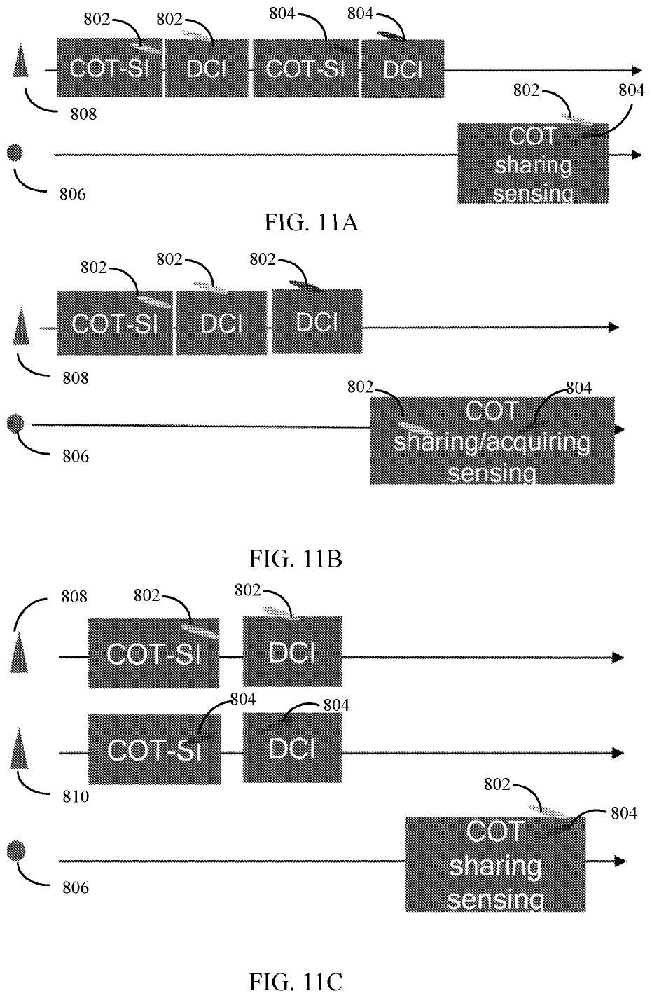

FIGS. 11A, 11B, and 11C depict example COT sharing scenarios during multi-DCI scheduling. As shown in FIG. 11A the UE 806 may receive a first COT-SI message and a first DCI, both indicating a first beam 802. The UE 806 may also receive a second COT-SI message and a second DCI, both indicating a second beam 804. The UE 806 may receive both COT-SI messages and both DCI from a single BS 808. The TCI state (i.e., beam) of each COT-message is explicitly included in a field of each COT-SI message, in some aspects. In other aspects, the UE 806 may deduce the TCI state of each COT-SI message based on the QCL relation of the PDCCH carrying each COT-SI message. Then, because a COT was obtained for the first beam 802 and the second beam 804, the UE 806 may determine to upgrade the LBT scheme of both beams to COT sharing.

As shown in FIG. 11B, the UE 806 may receive a first COT-SI message and a first DCI, both indicating a first beam 802. The UE 806 may also receive a second DCI indicating a second beam 804. Based on the COT-SI and the first DCI, the UE 806 may then determine to upgrade the LBT scheme of the first beam 802. However, since a COT-SI message was not received for the second beam 804, the UE 806 may still perform a more stringent LBT scheme for the second beam 804.

As shown in FIG. 11C, the UE 806 may receive a COT-SI message and a DCI, both indicating a first beam 802, from a BS 808. The UE 806 may also receive a COT-SI message and a DCI, both indicating a second beam 804, from another BS 810. Because a COT-SI message was obtained for the first beam 802 and the second beam 804, the UE 806 may determine to upgrade the LBT scheme of both beams.

While some examples provided herein have described techniques for determining an LBT scheme for transmission to different TRPs to facilitate understanding, the aspects described herein may be used to determine LBT schemes for transmissions to any suitable destination. For example, LBT schemes for transmissions via various beams may be used for sidelink communication between UEs.

### Example Wireless Communication Devices

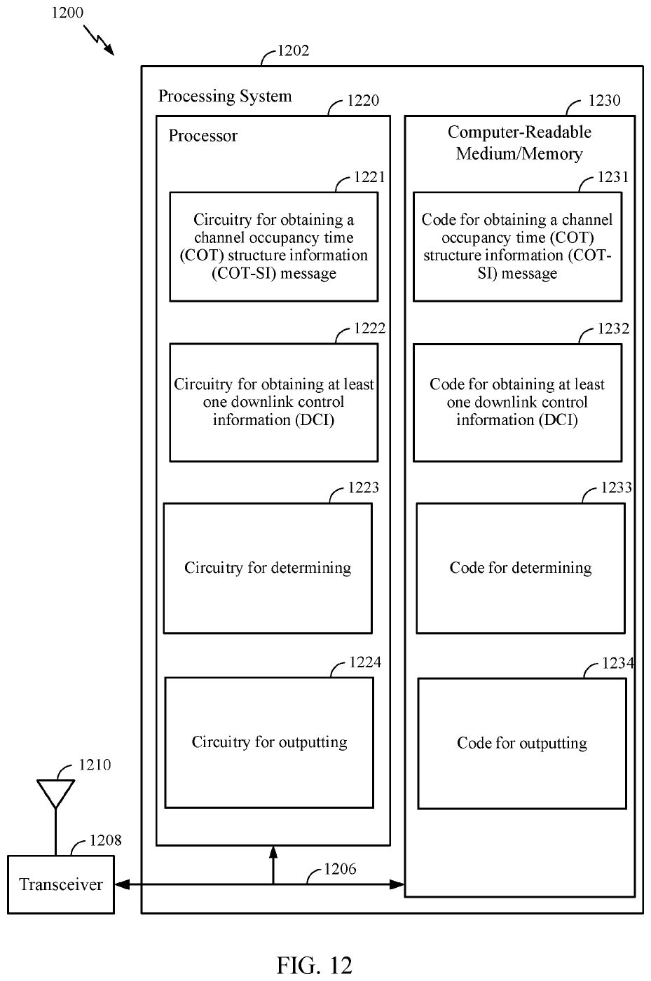

FIG. 12 depicts an example communications device 1200 that includes various components operable, configured, or adapted to perform operations for the techniques disclosed herein, such as the operations depicted and described with respect to FIGS. 7-11. In some examples, communication device 1200 may be a user equipment 104 as described, for example with respect to FIGS. 1 and 2.

Communications device 1200 includes a processing system 1202 coupled to a transceiver 1208 (e.g., a transmitter and/or a receiver). Transceiver 1208 is configured to transmit (or send) and receive signals for the communications device 1200 via an antenna 1210, such as the various signals as described herein. Processing system 1202 may be configured to perform processing functions for communications device 1200, including processing signals received and/or to be transmitted by communications device 1200.

Processing system 1202 includes one or more processors 1220 coupled to a computer-readable medium/memory 1230 via a bus 1206. In certain aspects, computer-readable medium/memory 1230 is configured to store instructions (e.g., computer-executable code) that when executed by the one or more processors 1220, cause the one or more processors 1220 to perform the operations illustrated in FIGS. 7-11, or other operations for performing the various techniques discussed herein for determine a listen before talk (LBT) scheme to be used for transmission via multiple beams based on LBT scheme indications and a COT structure information (COT-SI) message.

In the depicted example, computer-readable medium/memory 1230 stores code 1231 for obtaining a COT-SI message, code 1232 for obtaining at least one downlink control information (DCI), code 1233 for determining, and code 1234 for outputting.

In the depicted example, the one or more processors 1220 include circuitry configured to implement the code stored in the computer-readable medium/memory 1230, including circuitry 1221 for obtaining a COT-SI message, circuitry 1222 for obtaining at least one DCI, circuitry 1223 for determining, and circuitry 1224 for outputting.

Various components of communications device 1200 may provide means for performing the methods described herein, including with respect to FIGS. 7-11.

In some examples, means for transmitting or sending (or means for outputting for transmission) may include the transceivers 254 and/or antenna(s) 252 of the user equipment 104 illustrated in FIG. 2 and/or transceiver 1208 and antenna 1210 of the communication device 1200 in FIG. 12.

In some examples, means for receiving (or means for obtaining) may include the transceivers 254 and/or antenna(s) 252 of the user equipment 104 illustrated in FIG. 2 and/or transceiver 1208 and antenna 1210 of the communication device 1200 in FIG. 12.

In some examples, means for obtaining a COT-SI message, means for obtaining at least one DCI, means for determining, and means for outputting signaling for transmission on each of the multiple beams based on the LBT scheme, may include various processing system components, such as: the one or more processors 1220 in FIG. 12, or aspects of the user equipment 104 depicted in FIG. 2, including receive processor 258, transmit processor 264, TX MIMO processor 266, and/or controller/processor 280 (including LBT component 281).

In some example, means for outputting may include a bus interface, such as the bus 1206, and/or circuitry for outputting 1224, and/or code for outputting 1234, and/or LBT component 281. In some example, means for obtaining may include a bus interface, such as the bus 1206, and/or circuitry for obtaining 1221, circuitry for obtaining 1222, and/or code for obtaining 1231, code for obtaining 1232, and/or LBT component 281.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

Notably, FIG. 12 is an example, and many other examples and configurations of communication device 1200 are possible.

### Example Clauses

Implementation examples are described in the following numbered clauses:

Clause 1. A method for wireless communications at a user equipment, comprising: obtaining a channel occupancy time (COT) structure information (COT-SI) message; obtaining at least one downlink control information (DCI) indicating multiple beams and listen before talk (LBT) scheme indications associated with the multiple beams; determining an LBT scheme to be used for transmission via each of the multiple beams based on the LBT scheme indications and the COT-SI message; and outputting signaling for transmission on each of the multiple beams based on the LBT scheme.

Clause 2. The method of clause 1, wherein: the LBT scheme indications in the at least one DCI include at least one LBT scheme indication associated with at least one of the multiple beams, the COT-SI message indicating the at least one of the multiple beams; and determining the LBT scheme to be used for transmission via the at least one of the multiple beams comprises determining, based on the COT-SI message, to use a less stringent LBT scheme as compared to at least one LBT scheme associated with the at least one LBT scheme indication in the at least one DCI.

Clause 3. The method of any one of clauses 1-2, wherein: the LBT scheme indications in the at least one DCI include a first LBT scheme indication associated with a first beam of the multiple beams and a second LBT scheme indication associated with a second beam of the multiple beams; and determining the LBT scheme comprises determining to use a less stringent LBT scheme for the transmissions via the first beam and the second beam as compared to an LBT scheme associated with the first LBT scheme indication or the second LBT scheme indication, wherein the determination to use the less stringent LBT scheme is based on the at least one DCI and the COT-SI message being associated with a same cell-ID.

Clause 4. The method of any one of clauses 1-3, wherein determining the LBT scheme comprises determining to use a less stringent LBT scheme for transmission via a first beam of the multiple beams as compared to the LBT scheme to be used for transmission via a second beam of the multiple beams.

Clause 5. The method of any one of clauses 1-4, wherein: the LBT scheme indications in the at least one DCI include at least one LBT scheme indication associated with at least one of the multiple beams; and determining the LBT scheme comprises determining to use a less stringent LBT scheme for the transmission on the at least one of the multiple beams as compared to at least one LBT scheme associated with the at least one LBT scheme indication if the transmissions on all of the multiple beams use the less stringent LBT scheme.

Clause 6. The method of any one of clauses 1-5, further comprising performing LBT operations on the multiple beams in accordance with the determination, wherein the signaling is outputted for transmission via the multiple beams if the LBT operations performed on all the multiple beams are successful.

Clause 7. The method of any one of clauses 1-6, further comprising performing LBT operations on the multiple beams in accordance with the determination, wherein the signaling is outputted for transmission on a particular beam of the multiple beams if the LBT operation on the particular beam is successful.

Clause 8. The method of any one of clauses 1-7, further comprising obtaining an indication of an LBT scheme upgrade policy, the LBT scheme upgrade policy indicating whether the LBT scheme to be used for the transmission on a first one of the multiple beams can be changed to a less stringent LBT scheme as compared to the LBT scheme to be used for the transmission on a second one of the multiple beams.

Clause 9. The method of any one of clauses 1-8, further comprising obtaining an indication of a transmission policy, the transmission policy indicating whether the transmission on the multiple beams requires LBT operations for all of the multiple beams being successful, wherein the signaling is outputted for transmission in accordance with the transmission policy.

Clause 10. The method of any one of clauses 1-9, wherein a field in the COT-SI message indicates at least one of the multiple beams, and wherein the LBT scheme is determined based on the at least one of the multiple beams.

Clause 11. The method of any one of clauses 1-10, wherein the COT-SI message indicates one of the multiple beams using a quasi co-location (QCL) relation of a physical control channel (PDCCH) carrying the COT-SI message, and wherein the LBT scheme is determined based on the one of the multiple beams.

Clause 12. An apparatus for wireless communications, comprising: a memory comprising instructions; and one or more processors configured to execute the instructions and cause the apparatus to perform a method in accordance with any one of clauses 1-11.

Clause 13. A user equipment (UE), comprising: at least one transceiver; a memory comprising instructions; and one or more processors configured to execute the instructions and cause the user equipment to perform a method in accordance with any one of clauses 1-11, wherein the at least one transceiver is configured to receive the COT-SI and the at least one DCI and transmit signaling on each of the multiple beams based on the LBT scheme.

Clause 14. An apparatus for wireless communications, comprising means for performing a method in accordance with any one of clauses 1-11.

Clause 15. A non-transitory computer-readable medium comprising instructions that, when executed by an apparatus, cause the apparatus to perform a method in accordance with any one of clauses 1-11.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability specifications.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as BS 180 may operate in a traditional sub-6 GHz spectrum, in millimeter wave (mmWave) frequencies, and/or near mmWave frequencies in communication with the UE 104. When the BS 180 operates in mmWave or near mm Wave frequencies, the BS 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of determining a listen before talk (LBT) scheme to be used for transmission via multiple beams based on LBT scheme indications and a channel occupancy time (COT) structure information (COT-SI) message in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications at a user equipment, comprising:
obtaining a channel occupancy time (COT) structure information (COT-SI) message;
obtaining at least one downlink control information (DCI) indicating multiple beams and listen before talk (LBT) scheme indications associated with the multiple beams;
determining an LBT scheme to be used for transmission via each of the multiple beams based on the LBT scheme indications and the COT-SI message; and
outputting signaling for transmission on each of the multiple beams based on the LBT scheme.

2. The method of claim 1, wherein:
the LBT scheme indications in the at least one DCI include at least one LBT scheme indication associated with at least one of the multiple beams, the COT-SI message indicating the at least one of the multiple beams; and
determining the LBT scheme to be used for transmission via the at least one of the multiple beams comprises determining, based on the COT-SI message, to use a less stringent LBT scheme as compared to at least one LBT scheme associated with the at least one LBT scheme indication in the at least one DCI.

3. The method of claim 1, wherein:
the LBT scheme indications in the at least one DCI include a first LBT scheme indication associated with a first beam of the multiple beams and a second LBT scheme indication associated with a second beam of the multiple beams; and
determining the LBT scheme comprises determining to use a less stringent LBT scheme for the transmissions via the first beam and the second beam as compared to an LBT scheme associated with the first LBT scheme indication or the second LBT scheme indication, wherein the determination to use the less stringent LBT scheme is based on the at least one DCI and the COT-SI message being associated with a same cell-ID.

4. The method of claim 1, wherein determining the LBT scheme comprises determining to use a less stringent LBT scheme for transmission via a first beam of the multiple beams as compared to the LBT scheme to be used for transmission via a second beam of the multiple beams.

5. The method of claim 1, wherein:
the LBT scheme indications in the at least one DCI include at least one LBT scheme indication associated with at least one of the multiple beams; and
determining the LBT scheme comprises determining to use a less stringent LBT scheme for the transmission on the at least one of the multiple beams as compared to at least one LBT scheme associated with the at least one LBT scheme indication if the transmissions on all of the multiple beams use the less stringent LBT scheme.

6. The method of claim 1, further comprising performing LBT operations on the multiple beams in accordance with the determination, wherein the signaling is outputted for transmission via the multiple beams if the LBT operations performed on all the multiple beams are successful.

7. The method of claim 1, further comprising performing LBT operations on the multiple beams in accordance with the determination, wherein the signaling is outputted for transmission on a particular beam of the multiple beams if the LBT operation on the particular beam is successful.

8. The method of claim 1, further comprising obtaining an indication of an LBT scheme upgrade policy, the LBT scheme upgrade policy indicating whether the LBT scheme to be used for the transmission on a first one of the multiple beams can be changed to a less stringent LBT scheme as compared to the LBT scheme to be used for the transmission on a second one of the multiple beams.

9. The method of claim 1, further comprising obtaining an indication of a transmission policy, the transmission policy indicating whether the transmission on the multiple beams requires LBT operations for all of the multiple beams being successful, wherein the signaling is outputted for transmission in accordance with the transmission policy.

10. The method of claim 1, wherein a field in the COT-SI message indicates at least one of the multiple beams, and wherein the LBT scheme is determined based on the at least one of the multiple beams.

11. The method of claim 1, wherein the COT-SI message indicates one of the multiple beams using a quasi co-location (QCL) relation of a physical control channel (PDCCH) carrying the COT-SI message, and wherein the LBT scheme is determined based on the one of the multiple beams.

12. An apparatus for wireless communications at a user equipment, comprising:
a memory comprising instructions; and
one or more processors configured to execute the instructions and cause the apparatus to:
obtain a channel occupancy time (COT) structure information (COT-SI) message;
obtain at least one downlink control information (DCI) indicating multiple beams and listen before talk (LBT) scheme indications associated with the multiple beams;
determine an LBT scheme to be used for transmission via each of the multiple beams based on the LBT scheme indications and the COT-SI message; and
output signaling for transmission on each of the multiple beams based on the LBT scheme.

13. The apparatus of claim 12, wherein:
the LBT scheme indications in the at least one DCI include at least one LBT scheme indication associated with at least one of the multiple beams, the COT-SI message indicating the at least one of the multiple beams; and
determining the LBT scheme to be used for transmission via the at least one of the multiple beams comprises determining, based on the COT-SI message, to use a less stringent LBT scheme as compared to at least one LBT scheme associated with the at least one LBT scheme indication in the at least one DCI.

14. The apparatus of claim 12, wherein:
the LBT scheme indications in the at least one DCI include a first LBT scheme indication associated with a first beam of the multiple beams and a second LBT scheme indication associated with a second beam of the multiple beams; and
determining the LBT scheme comprises determining to use a less stringent LBT scheme for the transmissions via the first beam and the second beam as compared to an LBT scheme associated with the first LBT scheme indication or the second LBT scheme indication, wherein the determination to use the less stringent LBT scheme is based on the at least one DCI and the COT-SI message being associated with a same cell-ID.

15. The apparatus of claim 12, wherein determining the LBT scheme comprises determining to use a less stringent LBT scheme for transmission via a first beam of the multiple beams as compared to the LBT scheme to be used for transmission via a second beam of the multiple beams.

16. The apparatus of claim 12, wherein:
the LBT scheme indications in the at least one DCI include at least one LBT scheme indication associated with at least one of the multiple beams; and
determining the LBT scheme comprises determining to use a less stringent LBT scheme for the transmission on the at least one of the multiple beams as compared to at least one LBT scheme associated with the at least one LBT scheme indication if the transmissions on all of the multiple beams use the less stringent LBT scheme.

17. The apparatus of claim 12, wherein the one or more processors is further configured to cause the apparatus to perform LBT operations on the multiple beams in accordance with the determination, wherein the signaling is outputted for transmission via the multiple beams if the LBT operations performed on all the multiple beams are successful.

18. The apparatus of claim 12, wherein the one or more processors is further configured to cause the apparatus to perform LBT operations on the multiple beams in accordance with the determination, wherein the signaling is outputted for transmission on a particular beam of the multiple beams if the LBT operation on the particular beam is successful.

19. The apparatus of claim 12, wherein the one or more processors is further configured to cause the apparatus to obtain an indication of an LBT scheme upgrade policy, the LBT scheme upgrade policy indicating whether the LBT scheme to be used for the transmission on a first one of the multiple beams can be changed to a less stringent LBT scheme as compared to the LBT scheme to be used for the transmission on a second one of the multiple beams.

20. The apparatus of claim 12, wherein the one or more processors is further configured to cause the apparatus to obtain an indication of a transmission policy, the transmission policy indicating whether the transmission on the multiple beams requires LBT operations for all of the multiple beams being successful, wherein the signaling is outputted for transmission in accordance with the transmission policy.

21. The apparatus of claim 12, wherein a field in the COT-SI message indicates at least one of the multiple beams, and wherein the LBT scheme is determined based on the at least one of the multiple beams.

22. The apparatus of claim 12, wherein the COT-SI message indicates one of the multiple beams using a quasi co-location (QCL) relation of a physical control channel (PDCCH) carrying the COT-SI message, and wherein the LBT scheme is determined based on the one of the multiple beams.

23. The apparatus of claim 12, further comprising at least one transceiver configured to receive the COT-SI message and the at least one DCI and transmit signaling on each of the multiple beams based on the LBT scheme, wherein the apparatus is configured as the user equipment.

24. A user equipment (UE) for wireless communications, comprising:
at least one transceiver configured to:
receive a channel occupancy time (COT) structure information (COT-SI) message; and
receive at least one downlink control information (DCI) indicating multiple beams and listen before talk (LBT) scheme indications associated with the multiple beams;
a memory comprising instructions; and
one or more processors configured to execute the instructions and cause the UE to:
determine an LBT scheme to be used for transmission via each of the multiple beams based on the LBT scheme indications and the COT-SI message, wherein the transceiver is further configured to transmit signaling on each of the multiple beams based on the LBT scheme.
